(19) United States
(12) Patent Application Publication
(10) Pub. No.: US 2018/0157928 A1
(43) Pub. Date: Jun. 7, 2018

(54) IMAGE ANALYTICS PLATFORM FOR MEDICAL DATA USING EXPERT KNOWLEDGE MODELS

(71) Applicant: GENERAL ELECTRIC COMPANY, Schenectady, NY (US)

(72) Inventors: Dário Augusto Borges Oliveira, São Paulo (BR); Camila Patricia Bazilio Nunes, Rio de Janeiro (BR); Marina Lundgren de Almeida Magalhães, Rio de Janeiro (BR); Augusto de Jesus Araujo Marinho, Rio de Janeiro (BR); Flávio Henrique Schuindt Silva, Rio de Janeiro (BR); Marcelo Blois Ribeiro, Rio de Janeiro (BR); Isela Macia Bertrán, Rio de Janeiro (BR); Eudemberg Fonsec Silva, Rio de Janeiro (BR)

(21) Appl. No.: 15/371,636

(22) Filed: Dec. 7, 2016

(51) Int. Cl. G06K 9/46; G06T 7/10; G06T 7/00; G06T 7/32; G06F 19/00

(52) U.S. Cl. CPC G06K 9/46; G06T 7/10; G06T 7/0012; G06T 2207/30004; G06F 19/321; G06T 2207/20101; G06T 7/32

(57) ABSTRACT

Embodiments described herein provide an image analytics platform that follows a microservice-based architecture. The platform provides a set of algorithms implemented as microservices to design knowledge-based models. The image analytics platform is deployed in the cloud for management and storage of images. In order to facilitate the design, composition and integration of the algorithms, a web application facilitates design of the knowledge models by the use of directed graphs. The web application allows physicians to design specific knowledge models and share with others; developers can easily add and test new image processing algorithms; and physicians can design and test different algorithms and evaluate selected results in a more efficient way.

### FIELD

The subject matter disclosed herein relates to knowledge-sharing models, particularly as it relates to image analytics platforms for sharing medical data and professional expertise.

### BACKGROUND

The development of applications for medical image analysis is usually problem-driven and therefore very time and cost demanding, especially if it comprises a wider set of applications in different areas. Architectures for computer aided detection (CAD) and software systems for decision support in medical care have been evolving. Currently, general CAD does not specify any method for explicit knowledge definition or process algorithms for decision support in medicine. One prior system, however, suggests automated decision support in medical imaging; the general idea of processing medical images for decision support is disclosed, but no solution or method is provided as to explicit knowledge modeling. Additional concepts have been presented which relate to generalized semantic networks and process hierarchies; the implementations, however, relate to hierarchical tree schematics.

Despite currently existing approaches to date, none have been disclosed or implemented as proposed in the following disclosure. Systemic review of computer-assisted diagnosis for cancer has been suggested, for example, using diagnostic CAD to improve performance in cancer diagnosis studies. Other areas of utilizing CAD-based systems for decision support have been utilized in mammography, where high sensitivity is observed but poor specificity of current CAD schemes in breast cancer. The use of formal expert knowledge by building knowledge-based models is still neglected in CAD tools.

In addition, frameworks have been disclosed for image analysis of remote sensing data, but comprise knowledge based models and distributed execution using Pig Latin and a map reduction paradigm. An image processing workflow has also been previously presented using a front-end for connecting and configuring working patches and a back-end for running the pipeline in the cloud. While different algorithms have been proposed and integrated to workstations, the integration in the picture archive and communication system (PACS) environment and the application in a wide set of modalities remain a challenge.

A need exists to significantly improve performance of CAD-based systems for decision support in medicine and healthcare. Desirably, the improvements will provide a flexible framework to cope with different modalities while allowing the inclusion of up-to-date algorithms in dealing with different challenges in medical imaging. The improved system will provide a framework for image analysis of remote sensing data while addressing solutions tailored toward (i) a cloud-based software platform, and (ii) capability of dealing with volumetric medical image data. A front-end or back-end configuration will beneficially have graphical programming focused on knowledge representation, use and sharing, specifically designed in the healthcare domain and taking into account differing decision-making patterns and knowledge shared among physicians.

### SUMMARY

The above and other drawbacks or deficiencies may be overcome or alleviated by development of a system as described as follows. The invention provides a method for explicit knowledge definition and the use of algorithms to improve process in healthcare delivery. The explicit knowledge modeling will provide a flexible and robust implementation of graphical analyses for handling processes and definition of knowledge-based models, the architecture of which will beneficially be serviced in the cloud.

In one embodiment, an image analytics platform comprises knowledge-based sharing models comprising: image analytics services including one or more microservices to implement steps of image processing comprising: pre-processing, registration, segmentation, feature extraction, classification, and visualization, wherein pre-processing inputs are provided for an exam image during registration and adjustments; a user interface application that allows a user to input and upload data; an application program interface (API) that receives and manages requests from the user interface and initiates the one or more microservices; and a directed graph-based module that integrates the one or more microservices to structure execution of a workflow; wherein the one or more microservices are selected by the user and executed by the directed graph-based module to provide the knowledge-sharing models. The image analytics platform includes features extracted using feature statistics selected by the user at the user interface. In one aspect, the image analytics platform has seed points input by the user allowing the segmentation to extract an anatomical mask, and the exam image is processed through a user-selected segmentation to provide a first set unclassified objects. The first set of unclassified objects may be homogenous or roughly so. A spatial feature correlation may be utilized to identify the first set of unclassified objects to create a resulting identified object image that provides knowledge-sharing visualization. A second image upload to the user interface produces a second set of unclassified objects. As such, the second set of unclassified objects are identified and correlated during the spatial feature correlation with the first set of unclassified objects to deliver resulting identified objects to provide the knowledge-sharing visualization.

Aspects of the system utilize a user interface application that is a web-based application. The web-based application combines the image analytics services to provide in a scalable system. One or more healthcare delivery services may be implemented with the image analytics services. The directed graph-based module allows a user to develop knowledge-sharing in medical education, diagnosis, treatment, operations, and decision-support workflow. The API aggregates data from the user interface including physician background data, current decision-making, anonymized patient history data, among other usable data. In addition, the API aggregates data to allow a processor to predict future analytics.

A method of knowledge-sharing using image analytics comprising steps including: providing a platform using image analytics services, the image analytics services including a processor and one or more microservices to implement steps of image processing comprising: pre-processing, registration, segmentation, feature extraction, classification, and visualization, wherein the step of pre-processing, inputs are provided including an exam image uploaded to a user interface during registration and adjustments; providing a user interface allowing a user to select microservices including segmentation methodology, classification, and visualization in the user interface; receiving, at an application program interface (API), requests from the user interface; aggregating, at the API, the one or more microservices; and integrating a directed graph-based module that manages the microservices based on user-selected knowledge, wherein the directed graph-based module structures execution of a workflow to provide knowledge-sharing models. The method may further include a step of inputting seed points by a user. In the step of segmentation, an anatomical mask is created using the seed points.

Embodiments herein include microservices such as super segmentation to produce a set of roughly homogenous unclassified objects. As used herein, the term homogenous unclassified objects takes into account objects that are roughly or approximately homogenous. The microservices comprise feature computations as selected by a user to identify anatomy ontology of the unclassified objects. The microservices may also include spatial feature correlation. Additionally, the microservices are implemented individually, or in combination, as selected by a user at the user interface and aggregated by the API.

An embodiment of the software platform disclosed provides flexibility to develop and integrate improved algorithms with processing and memory capabilities enough to process a variety of medical images. The solution provides decision support in medical care to allow embedding of knowledge for medical image analytics while also handling distribution in the cloud. In one aspect, the decision support focuses on 2D and 3D imagery for biomarker selection and uses directed graphs to model knowledge.

In one embodiment, an open-source solution may provide an interactive workflow definition using data analysis and visualization with a focus on (i) service in cloud environments, (ii) volumetric medical image analysis; and (iii) a directed graph for automatic execution of knowledge model based pipelines. In another aspect, the image analysis goes beyond using trained algorithms for automatic detection of patterns in imagery data, and further allows explicit definition of knowledge and implements an explicit pipeline of processes to execute. Further, existing algorithms for automatic detection of patterns identification in images could be add-ons in the current approach as a service for automatic classification of a given specific pattern in a processes graph.

Embodiments disclosed here define a knowledge sharing process for defining knowledge and embedding knowledge that can be shared with experts. The system provides a flexible image analytics platform that implements this knowledge sharing process and allows development and deployment of image processing algorithms in the cloud. In addition, the system allows explicit definition of expert knowledge models through the use of flexible directed graphs. The graph(s) are used to robustly control the algorithms execution order. The proposed solution provides the means for expanding the algorithms of third-parties allowing the creation of an ecosystem for medical imaging analytics tools.

A non-transitory computer readable medium herein described comprises computer-readable instructions stored therein for causing a control processor to perform operations to determine explicit definitions of knowledge and provide a flexible framework to design directed graphs, or knowledge-sharing models. The processor selects and de-selects algorithm-based knowledge, as determined by a user, and implements knowledge selections as based on prior decisions and past results, current selections and processes, and creates possibilities for predicting image analytics and decision support.

Variations can thus be designed to accommodate different size, shapes, groups, and structures such that the methods can be accomplished in a cost-effective efficient manner. The structural system and architecture can be modified and components interchanged to achieve functionality and improvements as depicted in the detailed description and drawings.

### BRIEF DESCRIPTION OF THE DRAWINGS

FIG. 1 depicts a perspective view of an embodiment.

FIG. 2 depicts a perspective view in one aspect of the invention.

FIG. 3 depicts another perspective view in one aspect of the invention.

FIG. 4 represents an overall system including input and output images of embodiments of the system.

FIG. 5 is a representative schematic in one embodiment of the invention.

FIG. 6 depicts an image analytics platform in one embodiment.

FIG. 7 illustrates one embodiment of the invention utilizing user selections of knowledge and algorithms.

FIG. 8 illustrates another embodiment of the invention.

FIG. 9 is a schematic illustrating one embodiment of the invention.

FIG. 10 is a perspective view of embodiments including categorization, sub-categorization, and design of a graph node using uploaded input data.

FIG. 11 is a representation of one embodiment disclosed included knowledge-sharing and professional expertise as implemented in the delivery of a directed graph.

FIG. 12 depicts one aspect of image input data.

FIG. 13 depicts one embodiment of an output image using selected knowledge and user-defined specific parameters during processing of analytics.

FIG. 14 depicts an analytics image that represents a knowledge-based model in an embodiment that results from design of a user-defined directed graph prior to and during image processing.

### DETAILED DESCRIPTION

Various embodiments will be described more fully hereinafter with reference to the accompanying drawings. Such embodiments should not be construed as limiting. For example, one or more aspects can be utilized in other embodiments and even other types of devices. Referring to the drawings in general, it will be understood that the illustrations are for the purpose of describing particular embodiments and are not intended to be limiting.

This invention describes a software platform that follows a microservice-based architecture for analyzing medical imaging data in the cloud. The platform models a knowledge-based process formally described as a directed graph, which is composed of different algorithms implemented as narrow scope self-contained services. In the following analytic approaches, implementations provide a flexible and efficient platform to model expert knowledge through a combination of different algorithms, while pugging in improved algorithms in a straight-forward manner. The microservice-based architecture provides software quality factors to enable a flexible and robust system.

In one embodiment, to deploy knowledge-based models, directed graphs are utilized to combine different algorithms implemented as a microservice-based architecture hosted in the cloud for analyzing medical imaging data. The graph models allow physicians to embed their knowledge in a simple and intuitive way, which are then shared with other physicians for decision support and educational matters. While the use of a cloud infrastructure allows the optimization and scalability of processes, its combined use with directed graphs provides a flexible modelling of processes and a second level of process optimization through the parallelization of independent graph paths. For exemplary purposes, and not limitation, the system improvements include: (i) a visual process for defining expert knowledge models and deploying problem specific solutions to be shared with others; (ii) an image analytics platform in the cloud that provides infrastructure for using, developing, and deploying image processing algorithms, and (iii) a framework for sharing and using knowledge models represented as directed graphs to aid issues that arise with collaborative medical images interpretation. To validate, a web-based application for computer-aided diagnosis, has been developed herein to allows the design of expert knowledge models using a set of provided image processing algorithms. This set of image processing algorithms has been implemented as microservices with a well-defined application program interface (API) and deployed in the cloud environment, while the delivered web-application allows a user to easily design expert knowledge models as directed graphs. As such, the system provides a visual process of capturing expert knowledge using directed graphs, and a consequent framework for collaborative medical image interpretation in the cloud.

The software platform provides a microservice-based architecture in the cloud to allow fast and efficient development and deployment of different expert knowledge models for solving specific issues in diagnosis support using medical image data. The diagnosis process follows a workflow that is modelled based on expert knowledge, formally representing and making use of the knowledge in the execution of the algorithms to resolve issues with medical image data.

In one embodiment, a system is provided that incorporates medical imaging processing workflow comprising a combination of different modalities and processes. The workflow is directed towards formally modelling expert knowledge to create software systems that can beneficially integrate new and existing algorithms. In one aspect, the methodology may include contrast adjustment, affine registration, among others; the methodology includes expert knowledge available from different partners and users in the field.

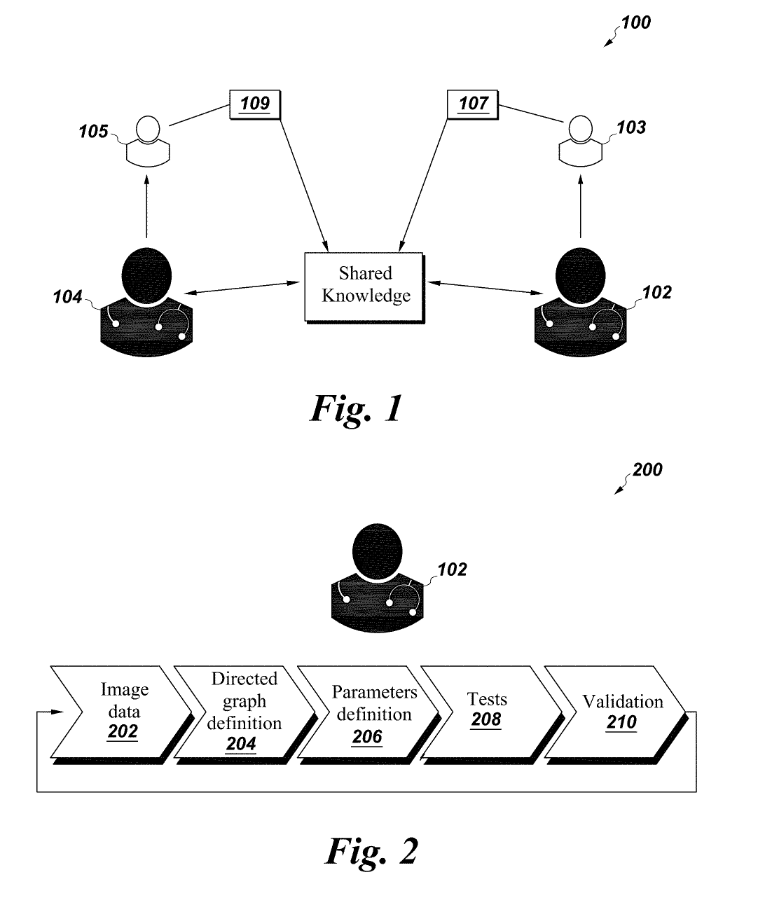

The process for medical image analytics, especially in the context of decision support, such as diagnosis or surgery planning, comprises the steps of (1) pre-processing, (2) registration, (3) segmentation, (4) feature extraction, (5) classification, and (6) visualization. Each of these steps comprise areas of research with many different algorithms available and modified improvements. In one aspect, the system addresses challenges in deploying applications in the medical informatics field to combine different algorithms to deliver satisfactory results for a very specific problem. As shown in FIG. 1, a system 100 is an image analytics platform that utilizes different algorithms in combination to find and identify anatomical structures. Here, for example, the anatomical structures inside the lungs are identified in a computed tomography (CT) image. Accurate results are achievable using specific algorithms for a set of applications; embodiments herein encompass the image analytics platform that allows fast development and deployment of efficient applications in different fields of medical imaging by allowing medicine experts to directly contribute to the knowledge model design.

Specifically, a directed graph is provided, flexible enough to model the workflow of decision support problems in medical imaging. While providing a representation of knowledge itself, the directed graph allows the combination of different processes, which are tested, validated, set-up and parallelized to deliver complex systems from simple and configurable blocks.

Embodiments described herein comprise an image analytics platform including three main aspects: knowledge sharing, image analysis, and cloud infrastructure. The image analytics platform allows building, orchestrating and sharing knowledge models based on image-processing algorithms.

Knowledge Sharing

Knowledge sharing allows knowledge, such as data, skills, and expertise to be exchanged among people. In the context of healthcare, tacit and documented knowledge embedded in processes provides quality and efficiency of patient care. When it comes to medical image analysis, knowledge sharing assists physicians and clinical teams in improving specific skills by learning from expert physicians' experiences and practices. The challenge of physicians not located physically within a facility is overcome here by providing easy access to opinions and expertise. For exemplary purposes, and not limitation, FIG. 1 illustrates a knowledge sharing model 100. In FIG. 1, Physician A (102) and Physician B (104) have patients (103, 105) with a possible brain tumor as based on data input from image scans (107, 109). Physician A has more experience than Physician B, but they have not met each other. Physician B benefits from Physician A's knowledge by receiving Physician A's knowledge to support his/her decision. The knowledge sharing model 100 provides an efficient systematic process that allows this sharing.

Embodiments disclosed propose a systematic process where physicians can easily embed and share specific knowledge with others. The client physicians can use the provided knowledge to improve aligned decision-making, personal and professional capabilities, test new data and learn other techniques. The process allows, for instance, less experienced physicians to benefit from knowledge models created remotely by experts in different fields of medicine. In one embodiment, in the process of using the knowledge sharing model 100, FIG. 2 illustrates a pipeline for defining and embedding knowledge in the knowledge model 200. The steps comprise defining:
a. Image Data (202). This step defines the type of image data and the sample to be analyzed. Examples of imaging data, without limitation, include magnetic resonance, ultrasound, mammography scanner, etc.
b. Directed graph(s) (204). In this step, the user or physician defines a knowledge model and image processing algorithms to be used in the process. The algorithms are combined by means of a directed graph that defines the order of execution of such algorithms, which individually or in combination, formally model the expert knowledge resources.
c. Parameters (206). Here, the user plays with and modifies experimental data to tune the parameters that are integrated with each algorithm. The parameters can vary depending on the expertise of the physician, type of image, or even type of problem to be analyzed.
d. Tests (208). This step ensures the defined graph is working properly and delivering the expected results in test data. The tests also provide evidence of the accuracy of the knowledge model(s), as defined by the physician.
e. Validation (210). In this step, other physicians evaluate the results obtained using other data to validate the defined knowledge model.

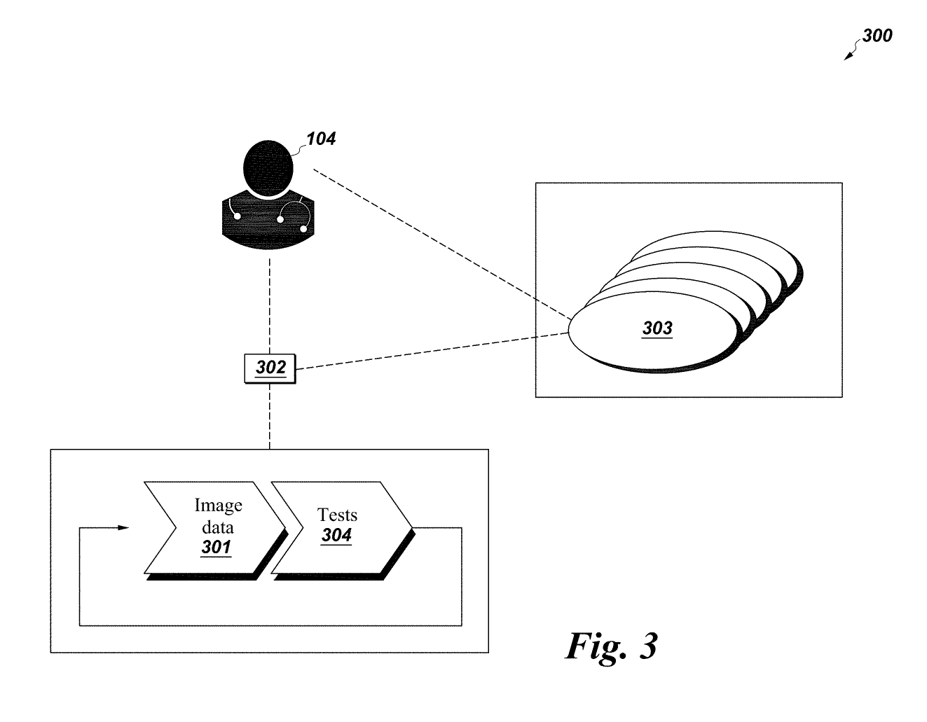

Once the knowledge model is exported, it can be used by others physicians, the client Physician B, for example. FIG. 3 illustrates the process of reusing a given knowledge model 300. Basically, the knowledge model 300 is used as a black box. The Physician B receives image data 301 from a patient, defines the parameters of the image dataset 302 using a selected knowledge model 303, and checks or tests the results 304 delivered by the selected knowledge model.

Image Analysis

Embodiments as described herein provide a software architectural platform that implements a microservice-based architecture in the cloud to allow the fast efficient development and deployment of different expert knowledge models for solving specific problems that involve medical image data. As used herein, software architecture takes a common well-defined meaning, including without limitation, reference to fundamental structures of a software system and documentation of these structures. In addition, the architecture includes representations of a system which includes mapping of functionality onto hardware and software components, a mapping of the software architecture onto the hardware architecture, human interaction with these components, and networking capabilities. The overall architecture includes structural components, integrated relationships, and associated characteristics and behaviors, the principles and guidelines governing design and real-time correction or updating of the system over time.

While medical image data is utilized in one embodiment, various data and datasets may be utilized and incorporated with the knowledge models. While implementing the knowledge definition and sharing process as shown in FIG. 2, the platform defines the image processing analysis to be used in the knowledge models.

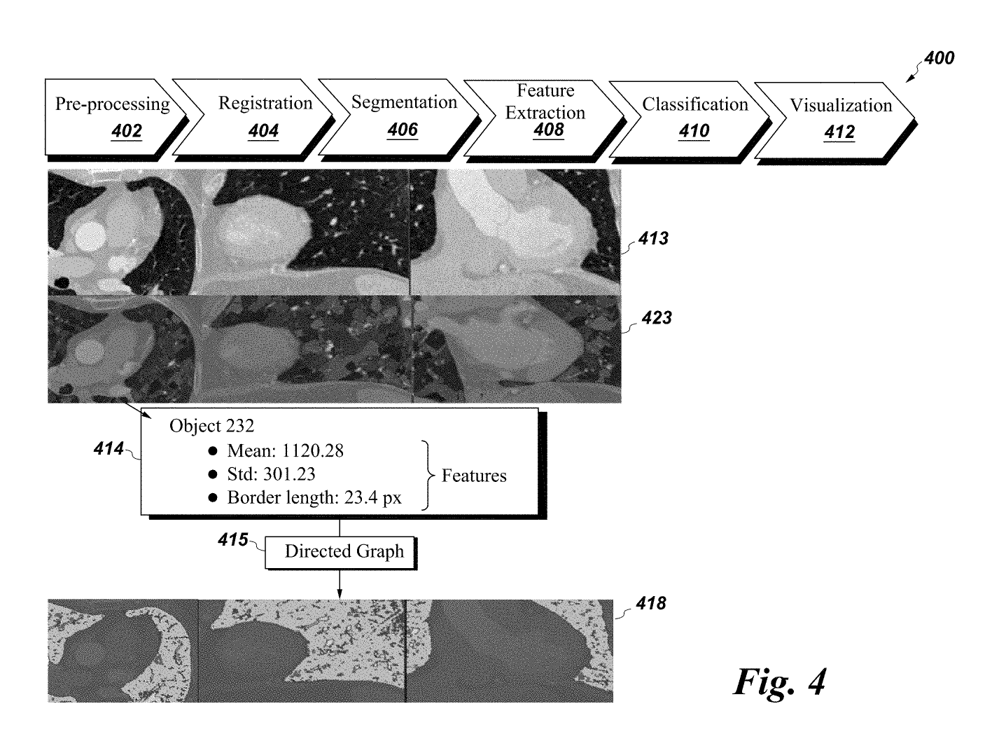

In one aspect, the diagnosis process includes a workflow that is modelled based on an expert knowledge. In another aspect, overall knowledge, skills, and experiences are incorporated to have an encompassing knowledge sharing model where data and analytics are analyzed, selected or deselected, and implemented as desired by a user. The knowledge sharing model with overall knowledge, skills, abilities, and experiences provides an assessment tool for preferred decision-making, effective and efficient patient care, diagnosis and treatment. The knowledge sharing model of FIG. 4 represents an architectural framework 400 that makes use of knowledge in the execution of algorithms to solve a specific problem in the medical image area.

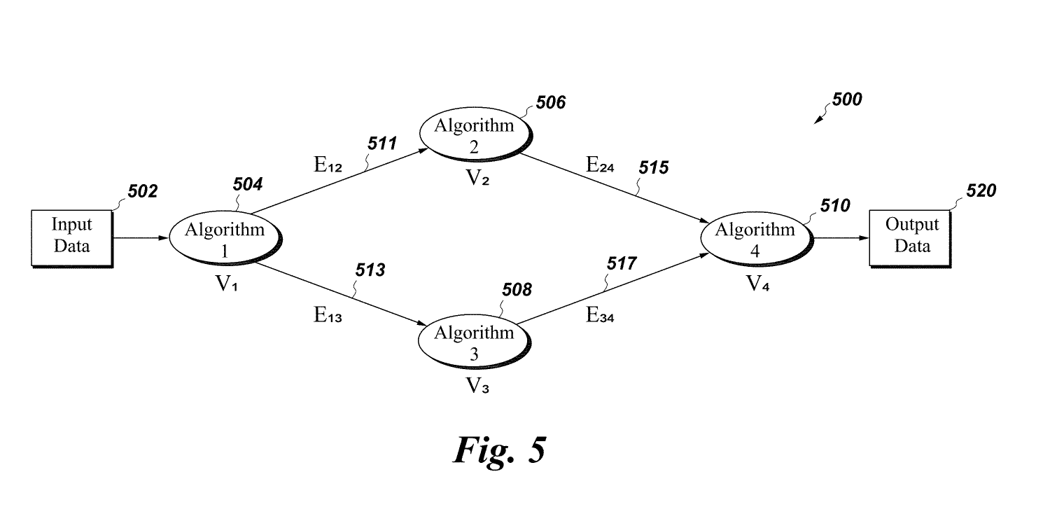

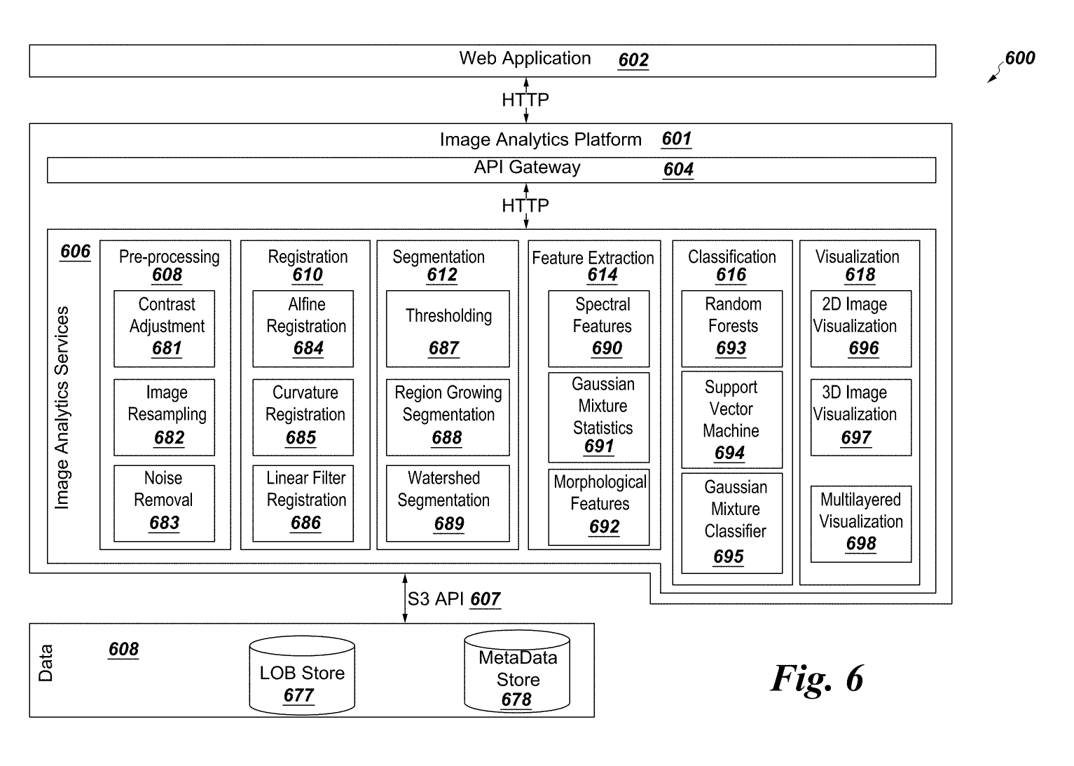

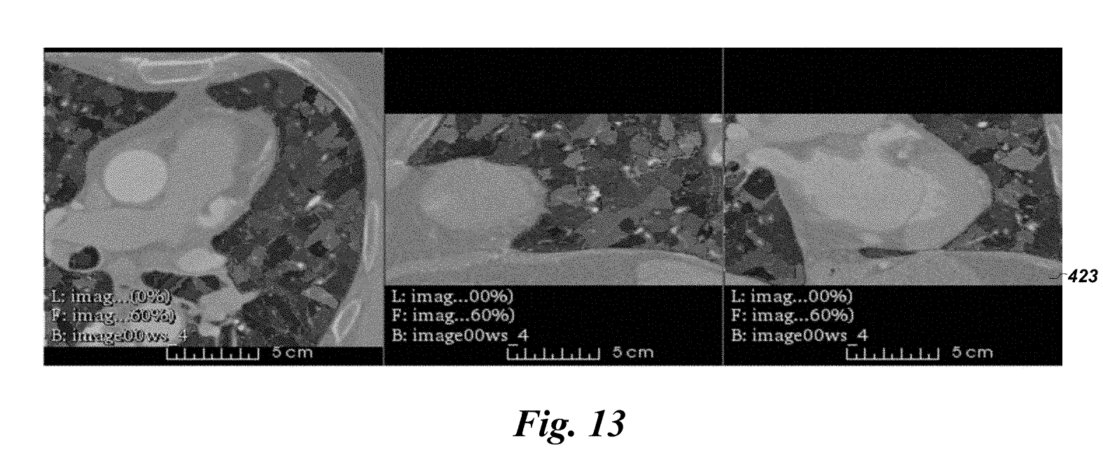

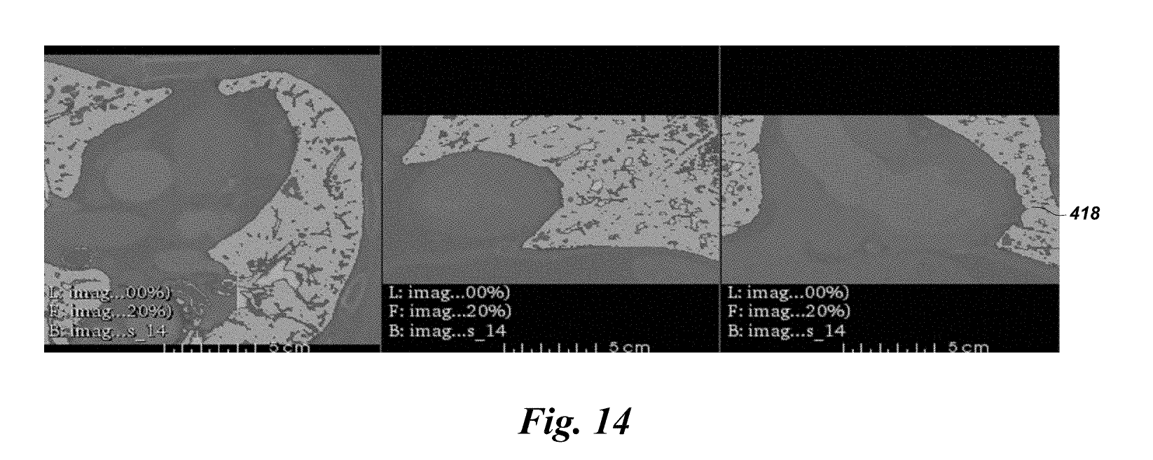

Medical imaging processing workflow comprises different modalities and processes, which are combined accordingly to deliver a result or a combination of results. Aspects of the invention provide formal modeling of these results, referred to herein as knowledge, to create software architectural systems that benefit directly from algorithms readily available to address, for example, contrast adjustment and affine registration, and also from the expert knowledge available from different partners. The process for medical image analytics as shown in FIG. 4, specifically in the context of decision support, such as diagnosis or surgery planning, and comprises the steps of: pre-processing 402, registration 404, segmentation 406, feature extraction 408, classification 410, and visualization 412. Each of these steps deploys various medical informatics algorithms and knowledge in the workflow, where different algorithms are combined to deliver results for a specific problem. In one aspect, FIG. 4 illustrates how different algorithms are combined to find anatomical structures inside the lungs from a computed tomography (CT) image. The input image of a pulmonary CT 413 (as shown in FIGS. 4 and 12) is provided to the knowledge model such as that shown in FIGS. 5 and 6. The output image 423 (as shown in FIGS. 4 and 13) of a 3D watershed algorithm with user specific parameters results in identified 3D watershed objects in the resulting analytics image 418 (as depicted in FIGS. 4 and 14). Accurate results are achieved using specific algorithms for a set of applications. Here, an image analytics platform 400 is provided that allows fast development and efficient deployment of applications in different fields of medical imaging by allowing medicine experts to directly contribute to the knowledge model design at each step of the process, individually or in combination.

A directed graph 415 provides a flexible model as part of the decision support architecture to accurately detail object(s) 414 in the resulting graphical medical images 418. This form of knowledge representation allows the combination of different processes, testing and validation of the results, set-up and parallelized to deliver efficient complex systems from simple and configurable blocks.

As shown in FIG. 5, a decision-support directed graph 500, the directed graph (G (E,V) includes E as a set of edges Eᵢⱼ (e.g. E₁₂, E₁₃, E₂₄, E₃₄) and connects different vertices Vᵢ from a set of vertices V. Each vertex Vᵢ (e.g., V₁, V₂, V₃, V₄) represents a different process associated with an algorithm for a specific task. Each edge implements the order in which the algorithms are executed to implement a complex knowledge-based process. Given a data input 502, a sequence of algorithms (504, 506, 508, 510) represented by different vertices (V₁, V₂, V₃, V₄) is executed following an order established by different edges (E₁₂, E₁₃, E₂₄, E₃₄), to deliver decision-supported results. In the example below, Algorithm 1 (504) receives the input data 502 and generates output data 511, 513 to be used, respectively, by the Algorithm 2 (506) and Algorithm 3 (508), which are executed in parallel. Algorithm 4 (510) waits for the execution of Algorithms 2 and 3, as well as for the availability of secondary output data 515, 517. Finally, it executes and generates the decision-support output data (520) from the complex process comprising Algorithms 1, 2, 3 and 4. This graphical representation is flexible enough to allow forks, loops and conditional situations.

Cloud Infrastructure

The system 600, as illustrated in FIG. 6, follows a microservice-based architecture on top of an open source cloud computing platform (PaaS). The image analytics platform 601 includes a set of services that implement different algorithms, individually implemented or in combination, to solve different medical image analyses. In addition, the image analytics platform 601 allows the development and deployment of new image algorithms, allowing access to independent microservices that communicate with each other using messages. Thus, microservices can be reused across several applications. The benefits of using microservices-based architectures are several, such as low coupling, small implementation and high cohesion, principles of software modularity. Additionally, the proposed architectural design, combining microservices and cloud infrastructure, allows easy maintenance and evolution of the developed applications. As presented in FIG. 6, the image analytics platform encompasses different modules: Web Application 602, API Gateway 604, Image Analytics Services 606, Data 608. Each module is described as follows:
(a) Web Application 602 implements a graph-based knowledge model that combines different image analytics services intuitively to allow the structured execution of a workflow that ultimately solves a complex problem. The benefits of having this graphical approach are several, such as: (i) scalability of problems as it provides a flexible way to model different problems; (ii) modular way to plug new services in the graphical interface; and (iii) user friendly application to process image analytics services. The use of the graph-based knowledge model in the healthcare industry facilitates development of new applications to solve different problems in medical imaging, diagnosis, treatment, operations, and decision-support workflow.
(b) API Gateway 604 acts as a single entry point for the broad scope of microservices. The API Gateway receives and manages requests coming from the web application, and calls the respective microservices. Additionally, the API Gateway is responsible for managing the input data and aggregating the respective data.
(c) Image Analytics Services 606 comprise microservices that implement the different image processing algorithms. Basically, a set of different microservices for each medical imaging decision support step are defined before the steps of: pre-processing 608, registration 610, segmentation 612, feature extraction 614, classification 616 and visualization 618. For exemplary purposes, and not limitation, a set of existing algorithms, including those of the National Library of Medicine Insight Segmentation and Registration Toolkit (ITK library), which is an open source C++ library for image analysis, are utilized at this step. Within the step of pre-processing 608, for example, steps include contrast adjustment 681, image resampling 682, noise removal 683, among others. Registration 610 includes steps such as affine registration 684, curvature registration 685, and linear filter registration 686. Segmentation 612 provides thresholding 687, region growing segmentation 688, and watershed segmentation 689. Feature extraction 614 comprises spectral features 690, Gaussian mixture statistics 691, morphological features 692, and others. Classification 616 includes such classifiers as random forests 693, support vector machine 694, Gaussian mixture classifier 695, and other classifiers. Visualization 618 comprises steps such as 2D image visualization 696, 3D image visualization 697, and multilayered visualization 698. Additionally, the goal of the platform allows the inclusion of new image processing algorithms through the combination with existing algorithms already available in the platform. For instance, regarding the pre-processing step, implemented services for contrast adjustment, image resampling, and noise removal has been integrated in the imaging processing analytics.
(d) Data 608 defines the access for updating, storing and recovering data in the cloud environment. In one aspect, a simple storage service is utilized (e.g., the storage service (S3) 607 provided by Amazon), which provides a secure and scalable object storage; LOB (line-of-business) Store 677 includes applications with integrated capabilities that tie into databases and database management systems, metadata storage 678, and other storage services.

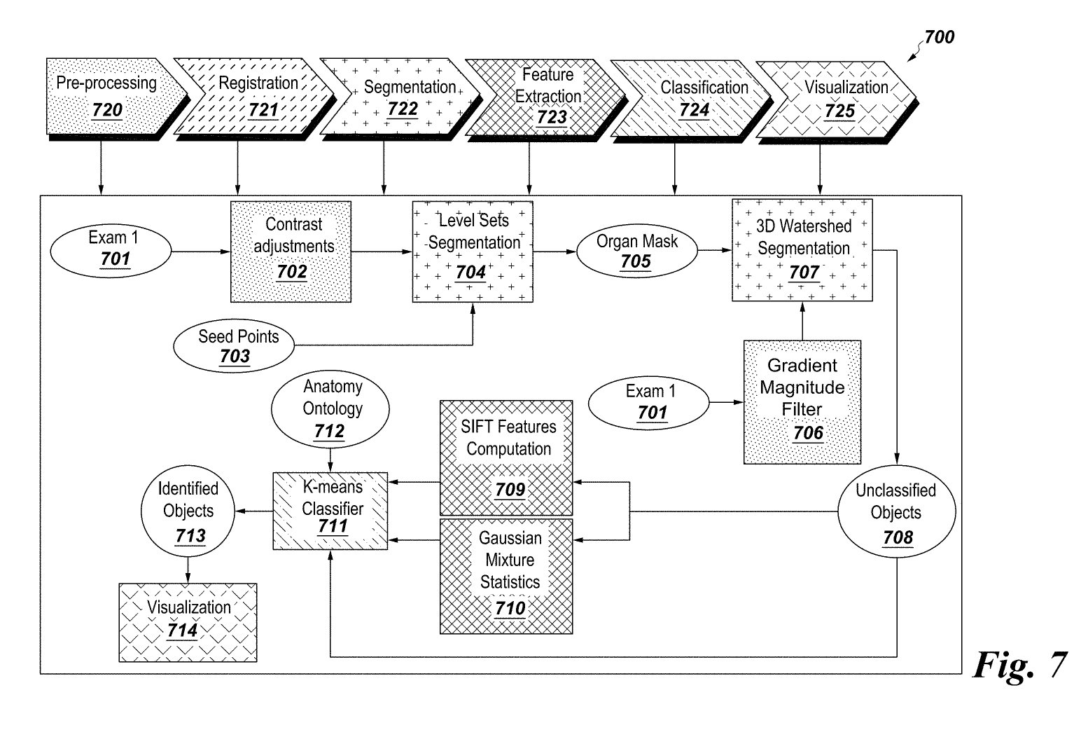

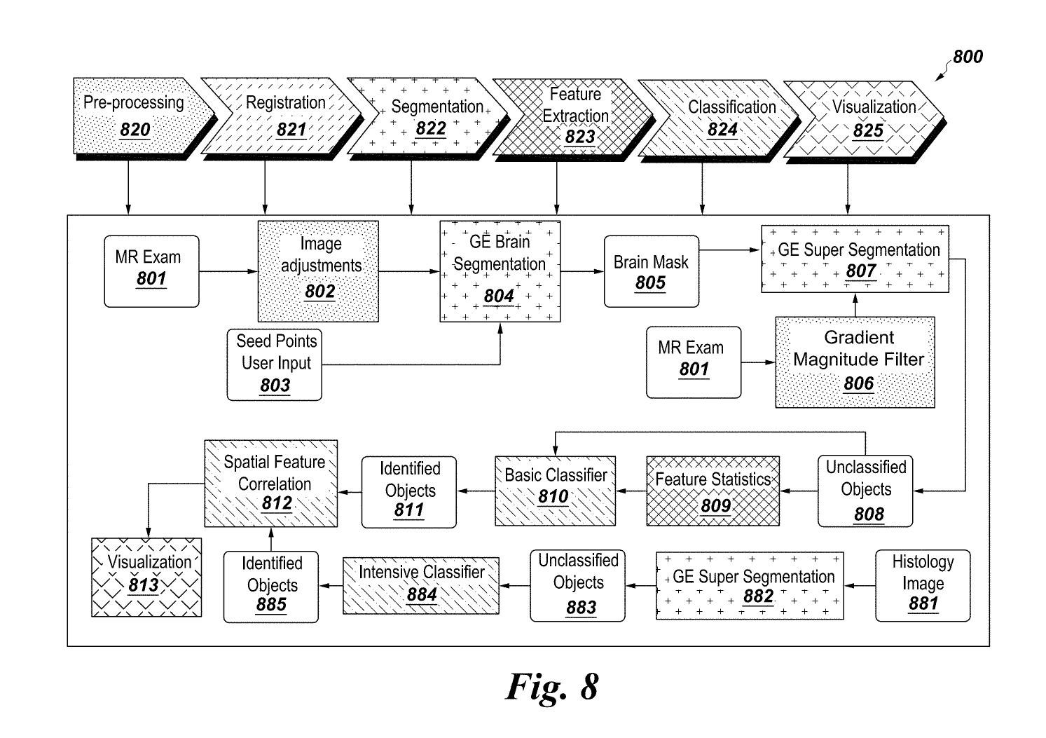

A more complex embodiment embeds expert knowledge to improve the performance of different algorithms, while allowing the construction of complex approaches from simpler building blocks. In one aspect, a domain expert composes meaningful graphical models combining algorithms that execute simpler tasks. For exemplary purposes, and not limitation, a complex process of identifies organs in computer tomography (CT) images that are roughly homogenous. FIG. 7 depicts homogenous anatomical structures as identified by a graphical model tied with image analytics, including pre-processing 720, registration 721, segmentation 722, feature extraction, 723, classification 724, and visualization 725. As shown in FIG. 7, a graphical model 700 utilizes different algorithms for several purposes, and combines the algorithms to achieve a desired result, as defined by a user. Initially, pre-processing inputs 720 are provided for a given exam, Exam 1 (701); during pre-processing 720, contrast adjustments 702 are made; registration proceeds 721; and seed points 703 are input by a user. A level sets segmentation algorithm 704 during the segmentation procedure 722 is then executed to extract an organ mask 705. Using the organ mask and the information from Exam 1, gradient magnitude filter 706 is input for a 3D watershed segmentation algorithm 707, allowing construction of a set of roughly homogenous, unclassified objects 708. Different features are computed using scale-invariant feature transform (SIFT) features computation 709 and Gaussian mixture statistics 710 for each object, using a K-means classifier 711 of the anatomy ontology 712 to classify objects into meaningful object classes, identified objects 713 which then allow visualization 714 of the object classes by a user. To build this graph and enable visualization, the domain expert embeds knowledge at different levels, defining which algorithms should be used to tackle the problem, in which order to arrange the algorithms, and further defines the parameters for each algorithm. Without this knowledge modeling, the problem cannot be tackled by any of the blocks individually.

Examples of Knowledge Models—Directed Graphs

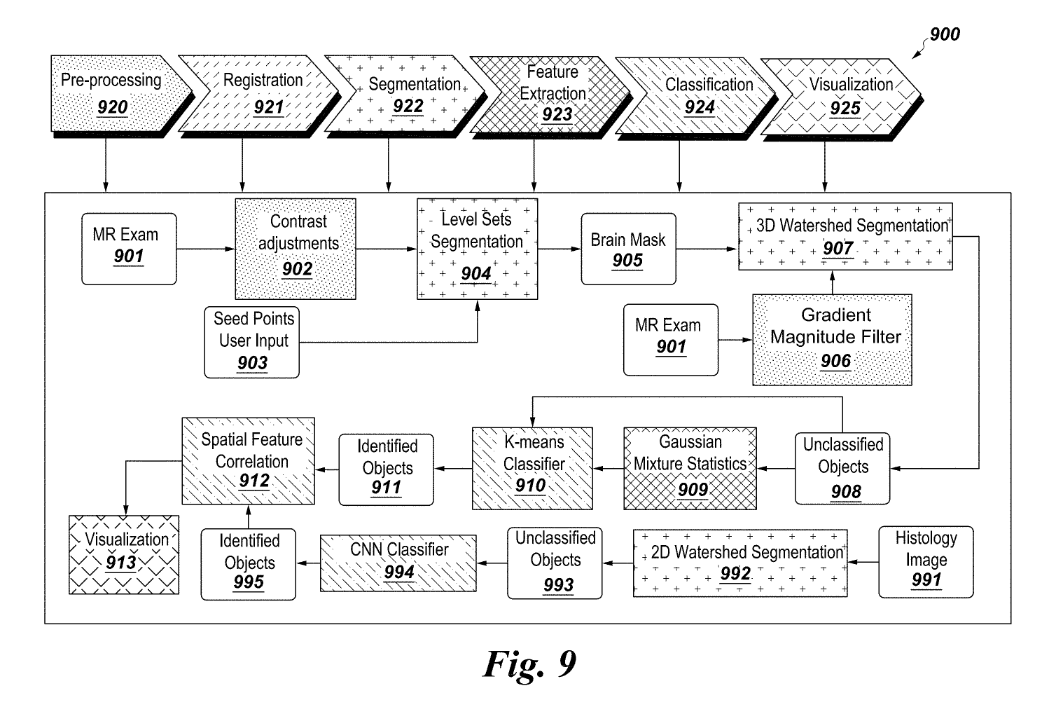

This section presents some examples of knowledge models formally described as directed graphs, which are shared among physicians, and other clinician experts. FIG. 8 and FIG. 9 depict different directed graphs, as based on different expert knowledge for solving a specific brain tumor detection problem. The definition of such graphs is based on a composition of existing algorithms and specific tuning of parameters. In FIG. 8, algorithms are defined as to brain segmentation and super segmentation. The image analytics platform of FIG. 8 proceeds from pre-processing 820, registration 821, segmentation 822, feature extraction, 823, classification 824, and visualization 825. As shown in FIG. 8, a graphical model 800 utilizes different algorithms for several purposes, and combines the algorithms to achieve a desired result, as defined by a user. Initially, pre-processing inputs 820 are provided for a given MR exam, 801; during registration 821, image adjustments 802 are made and then, seed points 803 are input by a user. A brain segmentation 804 during the segmentation procedure 822 and extracts a brain mask 805. Using the brain mask and the information the MR Exam 801, a gradient magnitude filter 806 is input for super segmentation 807, allowing construction of a set of roughly homogenous, unclassified objects 808. Different features are then extracted using feature statistics 809 and a basic classifier 810. The resulting identified objects 811 can then be processed through spatial feature correlation 812 for visualization 813. Simultaneously, a histology image 881 proceeds through super segmentation 882 to produce a second set of unclassified objects 883. Using intensive classifiers 884, a second set of identified objects 885 are correlated during spatial feature correlation 812 with the resulting identified objects 811 to provide the knowledge-sharing visualization 813.

In FIG. 9, existing algorithms are defined and implemented. The examples demonstrate that a final user does not need to know fancy algorithms to create knowledge models that rely on such complicated or intricate algorithms. Each block utilizes a clear scope and clear interface for parameter(s) definition. The image analytics platform of FIG. 9 proceeds from pre-processing 920, registration 921, segmentation 922, feature extraction, 923, classification 924, and visualization 925. As shown in FIG. 9, a graphical model 900 utilizes different algorithms for several purposes, and combines the algorithms to achieve a desired result, as defined by a user. Initially, pre-processing inputs 920 are provided for a given MR exam, 901; during registration 921, contrast adjustments 902 are made and then, seed points 903 are input by a user. A level sets segmentation 904 during the segmentation procedure 922 and extracts a brain mask 905. Using the brain mask and the information the MR Exam 901, a gradient magnitude filter 906 is input for image processing via 3D watershed segmentation 907, allowing construction of a set of roughly homogenous, unclassified objects 908. Different features are then extracted using Gaussian mixture statistics 909 and a basic classifier 910. The resulting identified objects 911 are then processed through spatial feature correlation 912 for visualization 913. Concurrently, a histology image 991 proceeds through 2D watershed segmentation 992 to produce a second set of unclassified objects 993. Using convolutional neural network (CNN) classifiers 994, a second set of identified objects 995 are correlated during spatial feature correlation 912 with the resulting identified objects 911 to provide the knowledge-sharing visualization 913.

This design in modeling of FIGS. 8 and 9 allows different models to compete for a similar goal and provide different insights for a similar problem. In both cases, the knowledge models are shared, commercialized and used for daily diagnostics by other physicians.

The challenges solved by this invention are directly applicable to the healthcare domain to share knowledge among clinical teams. The knowledge sharing models mitigate complexity and improve overall knowledge by supporting collaboration and coordination among professional medical providers. Prior lack of tools and processes for knowledge sharing have hindered collaboration and learning in different medicine fields; in this context, the embodiments disclosed herein focus on defining a knowledge sharing process, defining and embedding expert knowledge that is shared with others. Any number of analytics tools and platforms may be integrated with the system, specifically the image analytics platform that implements these processes and allows use, development and deployment of image processing algorithms in the cloud. The application developed provides creative design of models to solve complex problems by combining different algorithms by means of a directed graph. In this way, physicians and researchers from different areas can easily collaborate to create efficient knowledge models to tackle medical problems. This avoids common and time-consuming issues of building solutions from scratch for each specific condition of a patient, while providing an intuitive environment to reuse algorithms and models for fast deployment of complex solutions.

Moreover, the knowledge sharing models, herein referred to as directed graphs, formalize different expert knowledge models that can be used for decision support in the care of a patient, diagnosis, treatment, and educational matters. Less experienced physicians benefit from knowledge models created remotely by experts in different fields of medicine, improving the availability of expert knowledge. The image analysis platform makes state-of-art algorithms available, virtually in real-time, preventing the obsolescence of decision support tools related to medical imaging devices. The straightforward scalability of processes in the cloud support growing efforts in computational processing scale for medical imaging. The platform architecture conceptually delivers virtually unlimited computational processing capability without the use of local infrastructure. The platform creates an environment that works with multimodality devices as it is capable of modeling complex processes at an abstract level by using low-level algorithms implemented as microservices. Further, the platform allows the creation of an ecosystem for development of algorithms that facilitate the creation of knowledge-based models and cooperative decision support.

Embodiments of the invention report unique aspects related to knowledge sharing, an image analytics platform, expert knowledge models and composition of algorithms through directed graphs, which are not covered by existing tools or approaches. Aspects allow external partners to develop specific user-owned algorithms and reuse algorithms already provided by the image analytics platform, individually or in combination; using the image analytics platform, the deployment of image processing algorithms in the cloud is easily facilitated. Through use of the platform, experienced physicians can formally model self-knowledge and share with others as shared resource knowledge. In addition, the platform allows the definition and composition of different image processing algorithms to process image data coming from several medical modalities (e.g., Magnetic Resonance (MR), Computed Tomography (CT), Ultrasound, etc.). Advantageously, and in contrast with release-dependent solutions such as offline analysis workstations (WS), the architectural platform allows different research or clinical professional groups to add new algorithms for medical image interpretation related problems, ensuring the tool to remain constantly up-to-date, which is a big advantage when compared with release-dependent solutions such as offline analysis WS and PACS.

Further benefits and commercial aspects of embodiments pertaining to the platform thus described provide competitive differential as the software platform reduces development and deployment costs for external partners; the image analytics platform provides a set of algorithms in the cloud environment that can be easily reused to compose new applications. The algorithms already available by the image analytics platform are language-independent and allow the platform to be utilized with different software systems in fields of medical imaging. The platform has therefore enabled the algorithms to be developed as microservices. Physicians and other clinicians, health professionals, administrators, technologists, among other users can share their expert knowledge in a collaborative environment, which potentially allows better image understanding for different problems. The design, development, and deployment of algorithms can thereby integrate and interpret different images provided by various medical equipment and imaging modalities. In this manner, the platform provides flexibility to combine and test different algorithms and input data (e.g., exams, parametric data, etc.) through a web-based application that implements the expert knowledge-modeling tool. This further allows physicians and clinicians to use the application as an intuitive environment to model complex solutions.

This solution delivers economic advantages associated with image processing ecosystems in the cloud that allow collaborative and continuous development for diagnosing diseases and building scientific knowledge, the ecosystem analytics from explicit definition of knowledge. Compared to existing systems and the idea of image processing ecosystems, the software platform disclosed herein provides means to build a knowledge pipeline from highly varied image processing algorithms. In addition, it allows the attachment of new operations or image processing algorithms in the model. This kind of solution allows researchers from different groups to test and validate new ideas, and remotely contribute with new knowledge models and algorithms to collaboratively make diagnostic tools that incorporate different data samples and various aspects of parametric data. This characteristic allows the straightforward integration of new algorithms and knowledge models, which brings intrinsic economic impact with the opportunities of third parties algorithms and development of knowledge models easily monetized in a microservice-based architecture as the one provided in this disclosure.

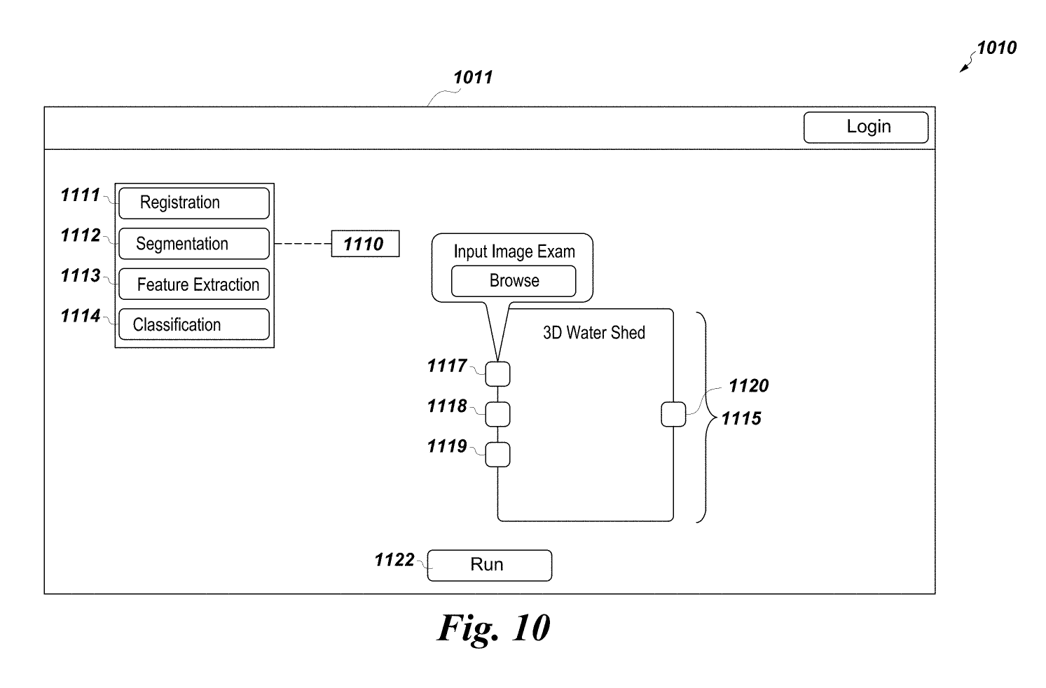

As demonstrated in the schematic of FIG. 10, an image analytics platform 1010 follows a microservice-based architecture that provides a set of algorithms implemented as microservices. The algorithms are utilized to design knowledge-based models. Additionally, modified and predictive algorithms can be deployed on the platform. The image analytics platform is developed on top of a cloud-based service and deployed with subscription-based infrastructure (i.e., Amazon). Cloud-based storage (i.e., Amazon S3) provides management and storage of acquired and processed images. As part of the platform, knowledge sharing models are designed by use of directed graphs in a web-based application. The web-based application allows: (i) physicians to design their knowledge models and share with others; (ii) developers to easily add and test new image processing algorithms; and (iii) physicians to design and test different algorithms and evaluate the user-defined results in a more efficient way.

Through the use of the web-based applications, users are able to build a knowledge model and select the algorithms to be used, upload data and download results. After logging into the subscription-based system, a user interacts with the platform 1010 at a user interface 1011, selecting from a list of algorithms already available in the software platform and organized in a menu 1110 with the groups corresponding to four steps of the medical imaging process for medical support: registration 1111, segmentation 1112, feature extraction 1113, and classification 1114, or as categorized and designed at the user interface. See FIG. 10. As the application is designed in the web-based application, each group or category in the menu 1110 comprises a set of algorithms to be selected during the composition of a knowledge model pipeline. Each selected algorithm has inputs and outputs. The sub-categorization 1122, here represented as 3D image processing, of the algorithms provides optional menus and drop-down information such as algorithm inputs and outputs. In one aspect, the user connects outputs to inputs of different blocks or uploads input data. A graph node 1115 is created and input uploaded 1116. Here, the graph node is a three-dimensional (3D) watershed algorithm block depicted with three inputs: a data image 1117, an initial mask image 1118, a parameter file as tabular data 1119, and one output image 1120. To upload the data, the user must click on the respective icon and the upload option will be displayed. In one aspect, the icons expand with branched information. In another aspect, updated pages provide the new data, such as the data image, initial mask image, and a parameter file. Once processing algorithms are selected, the data input and uploaded, and a graph node created, the user can execute the directed graph by selecting a run button 1122. Any number of algorithms and imaging processing data may be uploaded, selected, de-selected, and executed, as desired by a user and as based on the knowledge sought by the user in facilitating diagnosis, disease, treatment, and care of a patient, among other educational parameters.

Knowledge Model Design

In order to build the directed graph representing the knowledge model, a user selects different algorithms, combines the algorithms, and populates missing input data via uploading. With the model defined, the user runs the analysis and downloads the data available at each output of the different blocks incorporated in the graph.

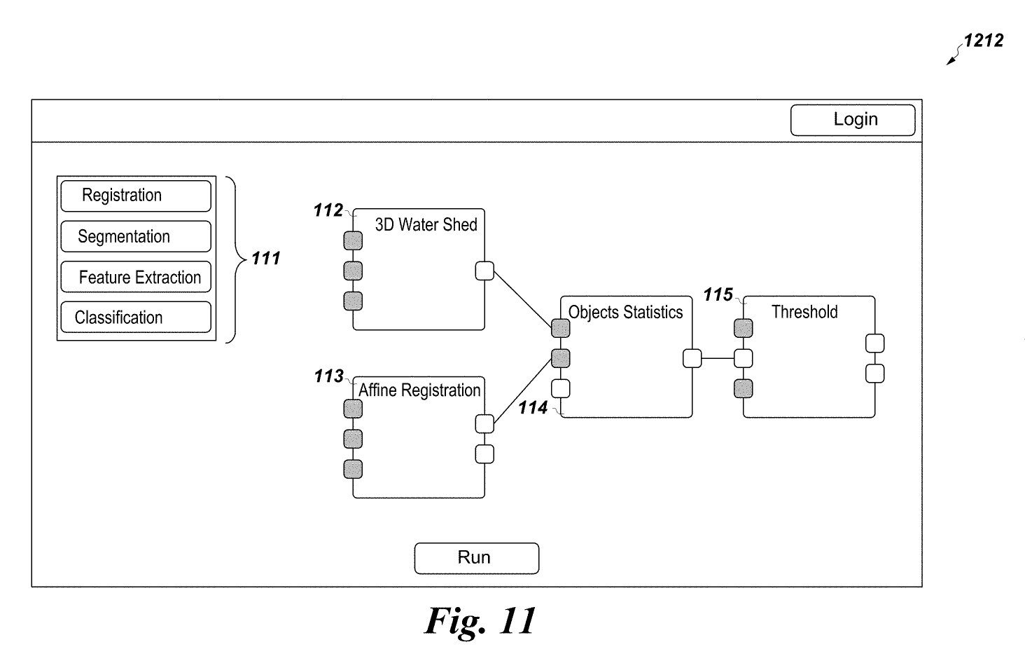

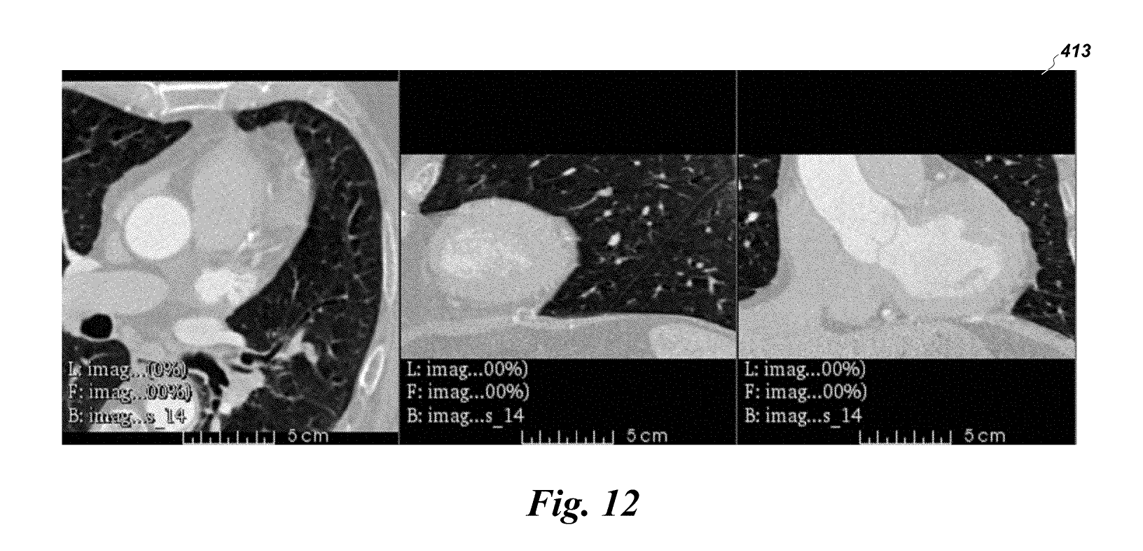

A perspective view of one embodiment of a directed graph 1212 is represented in FIG. 11. A menu 111 provides selections for a user to create knowledge-based graph nodes 112, 113, 114, 115, etc. When executed, the overall directed graph delivers results as shown in FIG. 4. By using a computed tomography (CT) exam from the lungs and an initial mask for the organs, a 3D watershed algorithm runs and generates a group of unclassified objects. Different object statistics are computed by an object statistics operator, which are used in a multi-threshold algorithm to classify the different objects in different classes, thus generating a classified label image of anatomical structures inside the lungs. Several different models can be generated for different purposes by using different algorithms and combinations. Embodiments allow for both the creation of algorithms to be combined, and the modelling of different knowledge based models by the use of directed graphs.

The validation of the analytics platform provides flexibility to develop and integrate new algorithms with processing and memory capabilities, enough to process different kinds of medical images. In addition, the web-based application makes easy-design knowledge models through the use of directed graphs. The web application further provides user-friendly tools where physicians or clinicians can create and evaluate knowledge models through the results produced by the analysis.

Data Resources

In embodiments disclosed, for exemplary purposes and not limitation, pulmonary test data is utilized by knowledge model above for testing the platform. As shown in FIG. 12, (presented before in FIG. 4), an input image of a pulmonary CT 413 is provided to the knowledge model 1212 of FIG. 11. FIG. 13 shows the output image 423 of a 3D watershed algorithm with specified parameters, resulting in 3D watershed objects in the resulting analytics image 418 as shown in FIG. 14. Specifically, FIG. 14 shows a multi-threshold classification analysis for labeling objects generated from the objects segmented in the watershed step. The results are visually consistent with the results expected. Color schemes in the imagery provide object identification, such as in the identification of pulmonary airways, main vessels, secondary vessels, pulmonary parenchyma, among others.

Embodiments may be modified and altered to deliver user-defined results without departing from the conceptual, logical, and hardware design architecture of the disclosed system. The system and platform described proposes a flexible, yet robust graph implementation for handling processes and definition of knowledge-based models, and modifications therein may be incorporated without departing from the nature and scope of the current invention. As such, while microservices disclosed may be based in the cloud, other private securer systems may be developed to incorporate the design and attributes of the knowledge-sharing architectural platform.

Aspects of the invention resolve issues that are currently experienced in the field. The platform allows the formalization of different expert knowledge models as used for decision support and educational decision-making guidance. It allows less experienced physicians to benefit from knowledge models created remotely by experts in different fields of medicine, improving the availability of expert knowledge. The platform enhances the use of state-of-art algorithms to be available virtually in real-time, preventing the obsolescence of decision support tools related to medical imaging devices.

Various embodiments of the invention may encompass any number of designs, configurations, conceptual, logical, and/or hardware-based architecture. While individual embodiments have been thus described, the individual embodiments may be integrated and combined for use with the platform. Configurations can be simplified and complexity minimized to reduce cost and provide easier implementation.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable instructions that when executed may instruct and/or cause a controller or processor to perform methods discussed and described above.

The computer-readable medium may be a non-transitory computer-readable media including forms and types of memory, and also may include computer-readable media except for a transitory, propagating signal. In one implementation, the non-volatile memory or computer-readable medium may be external memory.

Although specific hardware and methods have been described herein, any number of other configurations may be provided in accordance with embodiments of the invention. Thus, while fundamental novel features of the invention have been shown, described, and referenced, it will be understood that various omissions, substitutions, and changes in the form and details of the illustrated embodiments, and in operation thereof, may be made by those skilled in the art without departing from the spirit and scope of the invention. Substitutions of elements from one embodiment to another are also fully intended and contemplated. The invention is defined with regard to the claims appended hereto, and equivalents of the recitations therein.

While the invention has been described in considerable detail with reference to a few exemplary embodiments only, it will be appreciated that it is not intended to limit the invention to these embodiments only, since various modifications, omissions, additions and substitutions may be made to the disclosed embodiments without materially departing from the scope of the invention. In addition, many modifications may be made to adapt to a particular situation or an installation, without departing from the essential scope of the invention. Thus, it must be understood that the above invention has been described by way of illustration and not limitation. Accordingly, it is intended to cover all modifications, omissions, additions, substitutions or the like, which may be comprised within the scope and the spirit of the invention as defined by the claims.

1. An image analytics platform comprising knowledge-sharing models comprising:
image analytics services including one or more microservices to implement steps of image processing comprising: pre-processing, registration, segmentation, feature extraction, classification, and visualization, wherein pre-processing inputs are provided for an exam image during registration and adjustments;
a user interface application that allows a user to input and upload data;
an application program interface (API) that receives and manages requests from the user interface and initiates the one or more microservices; and
a directed graph-based module that integrates the one or more microservices to structure execution of a workflow;
wherein the one or more microservices are selected by the user and executed by the directed graph-based module to provide the knowledge-sharing models.

2. The image analytics platform of claim 1, wherein features are extracted using feature statistics selected by the user at the user interface.

3. The image analytics platform of claim 1, wherein seed points are input by the user allowing the segmentation to extract an anatomical mask, and the exam image is processed through a user-selected segmentation to provide a first set unclassified objects.

4. The image analytics platform of claim 3, wherein the first set of unclassified objects are homogenous, or approximately so.

5. The image analytics platform of claim 1, further comprising a spatial feature correlation that identifies the first set of unclassified objects to create a resulting identified object image that provides knowledge-sharing visualization.

6. The image analytics platform of claim 5, further comprising a second image upload to the user interface that produces a second set of unclassified objects.

7. The image analytics platform of claim 6, wherein the second set of unclassified objects are identified and correlated during the spatial feature correlation with the first set of unclassified objects to deliver resulting identified objects to provide the knowledge-sharing visualization.

8. The image analytics platform of claim 7, wherein the user interface application is a web-based application.

9. The image analytics platform of claim 8, wherein the web-based application combines the image analytics services to provide in a scalable system.

10. The image analytics platform of claim 9, further comprising one or more healthcare delivery services implemented with the image analytics services.

11. The image analytics platform of claim 10, wherein the directed graph-based module allows a user to develop knowledge-sharing in medical education, diagnosis, treatment, operations, and decision-support workflow.

12. The image analytics platform of claim 11, wherein the API aggregates data from the user interface including physician background data, current decision-making, anonymized patient history data.

13. The image analytics platform of claim 12, wherein the API aggregates data to allow a processor to predict future analytics.

14. A method of knowledge-sharing using image analytics comprising steps of:
providing a platform using image analytics services, the image analytics services including a processor and one or more microservices to implement steps of image processing comprising: pre-processing, registration, segmentation, feature extraction, classification, and visualization, wherein the step of pre-processing, inputs are provided including an exam image uploaded to a user interface during registration and adjustments;
providing a user interface allowing a user to select microservices including segmentation methodology, classification, and visualization in the user interface;
receiving, at an application program interface (API), requests from the user interface;
aggregating, at the API, the one or more microservices; and
integrating a directed graph-based module that manages the microservices based on user-selected knowledge, wherein the directed graph-based module structures execution of a workflow to provide knowledge-sharing models.

15. The method of claim 14, further comprising a step of inputting seed points by a user.

16. The method of claim 15, wherein the step of segmentation, an anatomical mask is created using the seed points.

17. The method of claim 16, wherein the microservices comprise super segmentation to produce a set of homogenous unclassified objects.

18. The method of claim 17, wherein the microservices comprise feature computations as selected by a user to identify anatomy ontology of the unclassified objects.

19. The method of claim 18, wherein the microservices include spatial feature correlation.

20. The method of claim 19, wherein the microservices are implemented individually, or in combination, as selected by a user at the user interface and aggregated by the API.
